(19) United States
(12) Patent Application Publication
(10) Pub. No.: US 2003/0122821 A1
(43) Pub. Date: Jul. 3, 2003

(54) Overlapping triangle meshes

(75) Inventor: George Politis, Macquarie Fields (AU)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/320,432

(22) Filed: Dec. 17, 2002

(30) Foreign Application Priority Data
Dec. 19, 2001 (AU) PR9631

(51) Int. Cl. G06T 15/40

(52) U.S. Cl. 345/421

(57) ABSTRACT

A method (800) of rendering a graphical object comprising a region of shaded color and/or opacity is disclosed. The method (800) specifies the shaded region in terms of a triangle mesh (e.g. 100) and identifies regions of the object where triangles overlap. In areas of the graphical object where overlap exists, the method (800) provides for both order-dependent and order-independent combining of color and opacity. The method (800) does not construct or scan convert an outline shape in order to determine winding counts. Instead, the method (800) works directly with the triangle mesh. The triangle mesh (100) can be derived from any source, for example, from the subdivision of Coons patches, or by direct construction without an intermediate representation of the color blend associated with the graphical object to be rendered. The method (800) can be used to render an object as conventional pixel output, or the object can be rendered in another form, for example, run-length encoded blends.

### TECHNICAL FIELD OF THE INVENTION

The present invention relates generally to computer graphics and, in particular, to the rendering of shaded triangle meshes. The present invention relates to a method and apparatus for the rendering of shaded triangle meshes. The invention also relates to a computer program product including a computer readable medium having recorded thereon a computer program for the rendering of shaded triangle meshes.

### BACKGROUND ART

Many conventional processing techniques exist in the field of two-dimensional computer graphics for providing quality output graphics. For example, methods fox the rendering of graphical objects having a solid color or a simple color gradient (e.g. a linear or radial blend between two colors) have been performed for a number of years. However, more recently, techniques such as Gouraud-shaded triangle meshes have been adapted from three-dimensional computer graphics for two-dimensional computer graphics, in order to increase the shapes and styles of color blends that can be produced in two-dimensional computer graphics.

The use of transparency and compositing is also now extensive in two-dimensional computer graphics. As well as color, many two-dimensional graphical objects now have an opacity indicating, for example, to what extent one graphical object obscures or reveals another graphical object on which the first graphical object is superimposed. As with color blends, opacity may be blended so that the opacity of an object varies from one point on the object to another.

Many techniques have been developed in relation to the compositing of graphical objects, in which two or more objects, each with color and transparency, interact to achieve various effects. However, less attention has been directed towards self-overlapping objects, in which one part of an object overlaps another part of the same object. If such an object is semi-transparent, the resultant color of the object can be difficult to determine.

Two existing methods for compositing graphical objects comprising irregularly shaped color blends are configured to sub-divide bicubic tensor patches (including ‘Coons’ patches, as known in the relevant art), representing the irregularly shaped color blends, into triangle meshes that can then be tendered using traditional three-dimensional graphics techniques.

Another existing method for compositing graphical objects comprising irregularly shaped color blends, analyses self-overlapping bicubic tensor patches and meshes of such patches representing the irregularly shaped color blends, by dividing the tensor patches into subpatches. The subpatches are then grouped into regions and the regions are rendered in a determined order so as to render overlapping regions correctly.

However, the above mentioned methods do not deal with transparency, or how to combine colors and opacities associated with overlapping regions. Furthermore, the above mentioned methods handle self-overlapping objects based on an analysis of bicubic patches. Such approaches do not work when a triangle mesh is initially presented for processing rather than a patch or mesh of patches from which the triangle mesh was derived, or with a triangle mesh that was constructed by means other than from parametric tensor patches.

Still another known method for compositing graphical objects defines graphical objects in terms of one or more outline shapes, each outline shape having a sense (or direction) along which an imaginary pen might run in order to draw the outline. This method calculates the winding count for each point or for a neighborhood of connected points, within an outline shape, as defined by the non-zero winding fill rule. The resulting color and opacity for a point on an object corresponding to the outline shape are defined as the repeated composition of color and opacity for the object with itself, a number of times being equal to the absolute value of the winding count. Thus, a region of overlap for an object is composited a number of times equal to the number of times that the object, corresponding to the outline shape, overlaps with itself within that region.

Still another known method for compositing graphical objects decomposes an irregularly shaped color and/or opacity blend into a triangle mesh, in which color and/or opacity may vary within each triangle and from one triangle to the next. This method constructs an outline shape for an object and uses the winding count for the outline shape to determine regions of self-overlap on a scan-line basis. Where the winding count indicates a region of overlap, special processing is performed to compute the resultant combination of contributing colors and opacity values. Where no overlap occurs, more efficient rendering is performed.

The method discussed in the preceding paragraph presents a formula for order-independent mixing of colors contributing to a resultant graphical object. However, the method requires the construction of an outline that needs to be scan converted. In addition, the method does not perform order-dependent rendering. Futhermore, the method described in the preceding paragraph does not deal with situations in which a triangle mesh is initially presented for processing, particularly where the triangle mesh is constructed by a means other than patches.

### SUMMARY OF THE INVENTION

It is an object of the present invention to substantially overcome, or at least ameliorate, one or more disadvantages of existing arrangements.

According to one aspect of the present invention there is provided a method of rendering a graphical object comprising a region of shaded color and/or opacity information, said region being divided into a plurality of triangular regions to form a triangle mesh representing said region, where one or more triangular regions of said mesh overlap, said method comprising the steps of:

(i) sorting said triangular regions in a predetermined direction to determine which of said triangular regions overlap in said predetermined direction;

(ii) compositing colour and/or opacity information associated at least with the overlapping triangular regions into an intermediate buffer; and

(iii) rendering said object according to said information contained in said intermediate buffer.

According to another aspect of the present invention there is provided a method of rendering a graphical object comprising a region of shaded color and/or opacity information, said region being divided into a plurality of triangular regions to form a triangle mesh representing said region, where one or more triangular regions of said mesh overlap, said method comprising the steps of:

(i) determining regions of overlap between said triangular regions;

(ii) compositing colour and/or opacity information associated at least with those triangular regions which overlap in a predetermined direction, into an intermediate buffer; and

(iii) rendering said object according to said information contained in said intermediate buffer.

According to still another aspect of the present invention there is provided an apparatus for rendering a graphical object comprising a region of shaded color and/or opacity information, said region being divided into a plurality of triangular regions to form a triangle mesh representing said region, where one or more triangular regions of said mesh overlap, said apparatus comprising:

sorting means for sorting said triangular regions in a predetermined direction to determine which of said triangular regions overlap in said predetermined direction;

compositing means for compositing colour and/or opacity information associated at least with the overlapping triangular regions into an intermediate buffer; and

rendering means for rendering said object according to said information contained in said intermediate buffer.

According to still another aspect of the present invention there is provided an apparatus for rendering a graphical object comprising a region of shaded color and/or opacity information, said region being divided into a plurality of triangular regions to form a triangle mesh representing said region, where one or more triangular regions of said mesh overlap, said apparatus comprising:

region overlap determining means for determining regions of overlap between said triangular regions;

compositing means for compositing colour and/or opacity information associated at least with those triangular regions which overlap in a predetermined direction, into an intermediate buffer, and

rendering means for rendering said object according to said information contained in said intermediate buffer.

According to still another aspect of the present invention there is provided a computer program for rendering a graphical object comprising a region of shaded color and/or opacity information, said region being divided into a plurality of triangular regions to form a triangle mesh representing said region, where one or more triangular regions of said mesh overlap, said program comprising:

code for sorting said triangular regions in a predetermined direction to determine which of said triangular regions overlap in said predetermined direction;

code for compositing colour and/or opacity information associated at least with the overlapping triangular regions into an intermediate buffer; and

code for rendering said object according to said information contained in said intermediate buffer.

According to still another aspect of the present invention there is provided a computer program for rendering a graphical object comprising a region of shaded color and/or opacity information, said region being divided into a plurality of triangular regions to form a triangle mesh representing said region, where one or more triangular regions of said mesh overlap, said program comprising:

code for determining regions of overlap between said triangular regions;

code for compositing colour and/or opacity information associated at least with those triangular regions which overlap in a predetermined direction, into an intermediate buffer; and

code for rendering said object according to said information contained in said intermediate buffer.

Other aspects of the invention are also disclosed.

### BRIEF DESCRIPTION OF THE DRAWINGS

One or more embodiments of the present invention will now be described with reference to the drawings, in which:

FIG. 1 shows a sample triangle mesh;

FIG. 2 is a flow chart showing a method for pre-processing a triangle mesh;

FIG. 3 shows a triangle and the data structures defining the triangle;

FIG. 4 shows a data structure for an edge of a triangle;

FIG. 5 shows a data structure for a triangle;

FIGS. 6(a) to (d) shows various orientations for the edges of a triangle;

FIG. 7 shows the triangle of FIG. 6(a) in more detail;

FIG. 8 is a flow chart showing a method for rendering a triangle mesh;

FIG. 9 is a flow chart showing a method for producing one scan line of output as executed in the method of FIG. 8;

FIG. 10 is a flow chart showing a method of advancing an active list to a next scan line as executed in the method of FIG. 8; and

FIG. 11 is a schematic block diagram of a general-purpose computer upon which arrangements described can be practiced.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

A method of rendering a graphical object comprising a region of shaded color and/or opacity is described below. The method specifies the shaded region in terms of a triangle mesh and identifies regions of the object where triangles overlap. In areas of the graphical object where overlap exists, the method provides for both order-dependent and order-independent combining of color and opacity. The method does not construct or scan convert an outline shape in order to determine winding counts. Instead, the method works directly with the triangle mesh. The triangle mesh can be derived from any source, for example, from the subdivision of Coons patches, or by direct construction without an intermediate representation of the color blend associated with the graphical object to be rendered. The method can be used to render an object as conventional pixel output, or the object can be rendered in another form, for example, run-length encoded blends.

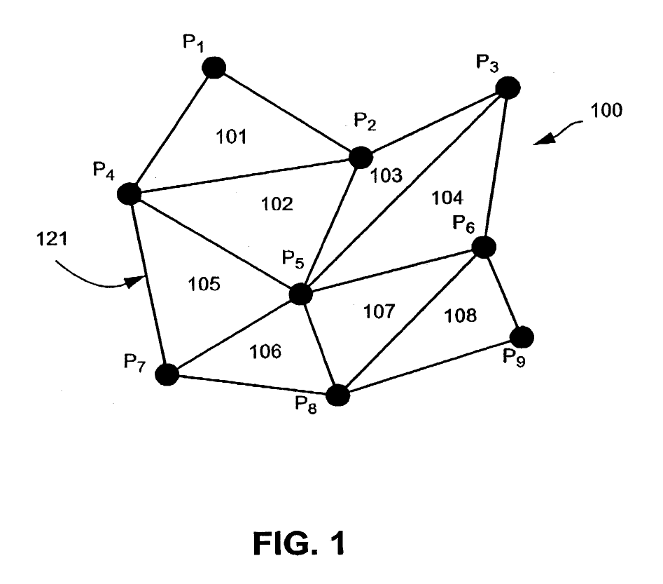

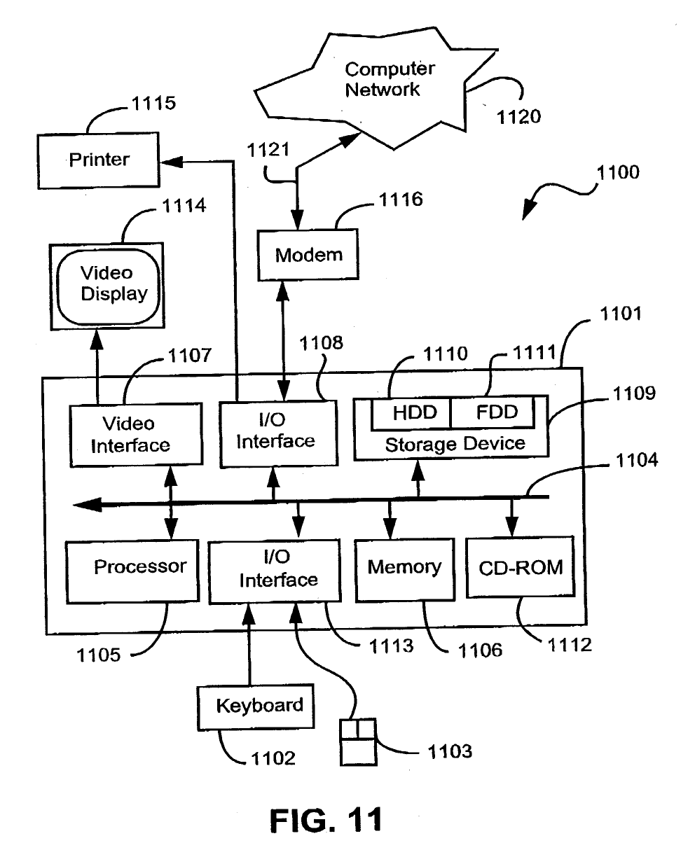

The methods described herein can be practiced using a general-purpose computer system 1100, such as that shown in FIG. 11 wherein the processes of FIGS. 1 to 11 may be implemented as software, such as an application program executing within the computer system 1100. Alternatively, the methods described herein can be practiced in an embedded system (e.g. incorporated in a driver module for a photocopier control panel). In particular, the steps of methods described herein are effected by instructions in the software that are carried out by the computer. The instructions may be formed as one or more code modules, each for performing one or more particular tasks. The software may also be divided into two separate parts, in which a first part performs the described methods and a second part manages a user interface between the first part and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for rendering a graphical object in accordance with the methods described herein.

The computer system 1100 comprises a computer module 1101, input devices such as a keyboard 1102 and mouse 1103, output devices including a printer 1115 and a display device 1114. A Modulator-Demodulator (Modem) transceiver device 1116 is used by the computer module 1101 for communicating to and from a communications network 1120, for example connectable via a telephone line 1121 or other functional medium. The modem 1116 can be used to obtain access to the Internet, and other network systems, such as a Local Area Network (LAN) or a Wide Area Network (WAN).

The computer module 1101 typically includes at least one processor unit 1105, a memory unit 1106, for example formed from semiconductor random access memory (RAM) and read only memory (ROM), input/output (I/O) interfaces including a video interface 1107, and an I/O interface 1113 for the keyboard 1102 and mouse 1103 and optionally a joystick (not illustrated), and an interface 1108 for the modem 1116. A storage device 1109 is provided and typically includes a hard disk drive 1110 and a floppy disk drive 1111. A magnetic tape drive (not illustrated) may also be used. A CD-ROM drive 1112 is typically provided as a non-volatile source of data. The components 1105 to 1113 of the computer module 1101, typically communicate via an interconnected bus 1104 and in a manner which results in a conventional mode of operation of the computer system 1100 known to those in the relevant art. Examples of computers on which the described arrangements can be practiced include IBM-PC's and compatibles, Sun Sparestations or alike computer systems evolved therefrom,

Typically, the application program is resident on the hard disk drive 1110 and read and controlled in its execution by the processor 1105. Intermediate storage of the program and any data fetched from the network 1120 may be accomplished using the semiconductor memory 1106, possibly in concert with the hard disk drive 1110. In some instances, the application program may be supplied to the user encoded on a CD-ROM or floppy disk and read via the corresponding drive 1112 or 1111, or alternatively may be read by the user from the network 1120 via the modem device 1116. Still further, the software can also be loaded into the computer system 1100 from other computer readable media. The term “computer readable medium” as used herein refers to any storage or transmission medium that participates in providing instructions and/or data to the computer system 1100 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 1101. Examples of transmission media include radio or infra-red transmission channels as well as a network connection to another computer or networked device, and the Internet or Intranets including email transmissions and information recorded on websites and the like.

The methods described herein may alternatively be implemented in dedicated hardware such as one or more integrated circuits performing the functions or sub functions of FIGS. 1 to 11. Such dedicated hardware may include graphic processors, digital signal processors, or one or more microprocessors and associated memories.

Input to the methods described herein is preferably a list of triangles, with colour and/or opacity specified at each triangle vertex. In the following description, it will be assumed that both colour and opacity are given, and that colour is specified in terms of red, green and blue components, being a commonly used configuration. However, different colour spaces (e.g. CMYK or L*a*b*), grey-scale blends, opacity-only blends, and other colour configurations are possible by changing the number and names of the colour components.

If overlapping triangles are required to be composited in a given order, then such must be specified in the input data. Such may be implicit in the input data (e.g., the order in which triangles are presented), or explicit in the input data (e.g., each triangle can be numbered to indicate the order).

FIG. 1 shows a sample triangle mesh 100 comprising eight triangles 101 to 108. For visual clarity, no overlapping triangles are shown in this example. However, a triangle mesh can include overlapping triangles. The triangles 101 to 108 are formed of three vertices each, from the set of vertices P₁ to P₉. Each vertex P₁ has corresponding co-ordinates (xᵢ, yᵢ), colour (rᵢ, gᵢ, bᵢ) and opacity aᵢ. Each triangle also comprises three edges (e.g. edge 121 which will be referred to herein using the notation P₄P₇), with each edge linking two vertices. For example, triangle 101 is formed by the vertices P₁, P₂ and P₄, and comprises edges P₁P₂, P₂P₄ and P₄P₁. Note that triangles commonly share edges with other triangles.

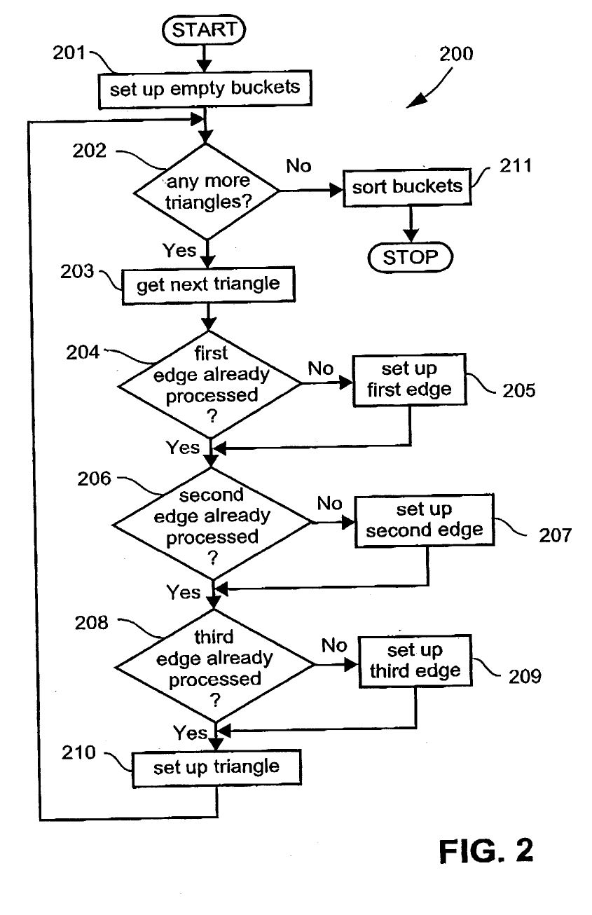

Before rendering of the triangle mesh 100 can proceed, certain pre-processing is required. FIG. 2 is a flow chart showing a method 200 for pre-processing a triangle mesh. The method 200 is preferably implemented as software being resident on the hard disk drive 1110 and being read and controlled in its execution by the processor 1105. The method 200 begins at the first step 201, where an array of buckets (as known in the relevant art) are configured by the processor 1105 for sorting triangles. In the method 200, triangles are sorted firstly by the scan line each triangle intersects, and secondly by the minimum x-co-ordinate of the intersection of the scan line and the edges of the triangle. Step 201 includes the sub-steps of (i) determining what range of scan lines the triangle mesh spans; (ii) allocating an array of buckets for each scan line in this range; and (iii) initialising each bucket to an empty list. A person skilled in the relevant art would appreciate that other variations on these sub-steps can be used to implement step 201. For example, the range of scan lines spanned by the triangle mesh may already be known by other means, and other sorting methods may be substituted for bucket sorting.

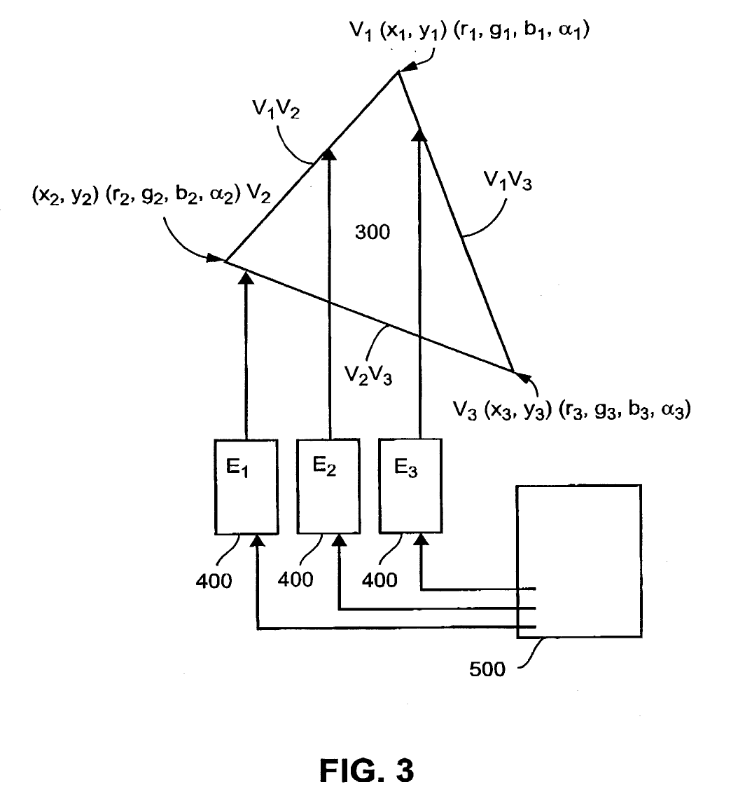

At the next step 202, a test is performed by the processor 1105 to determine if there are any more triangles in the mesh. Step 202 is used by the processor 1105 to control a loop over each triangle of the mesh. The method 200 continues at the next step 203, where the data defining a next triangle to be processed is obtained, typically from the memory 1106. For example, FIG. 3 shows a triangle 300 and the data defining the triangle 300. This data includes vertex co-ordinates, V₁ (x₁, y₁), V₂ (x₂, y₂) and V₃ (x₃, y₃), corresponding colours and opacities for each vertex, (r₁, g₁, b₁, a₁), (r₂, g₂, b₂, a₂) and (r₃, g₃, b₃, a₃) and a priority p.

In the following steps 204, 206 and 208 of the method 200, the edges V₂V₃, V₁V₃ and V₁V₂, respectively, are examined to test if any of the edges have already been processed. An edge will be found to have already been processed if an edge shared by two triangles as their conmmon boundary is processed, as part of one of the triangles, in a previous iteration of the loop. One method of determining whether an edge has already been processed is to set up a mapping from pairs of vertices to edge data structures (to be described below), using a hash table, or some other means as known in the relevant art. Edges with the same two vertices are matched regardless of the order of the vertices (e.g., edge P₁P₂ and P₂P₁ are treated as the same edge). This can be achieved by sorting the two vertices of an edge, for example, first by y-co-ordinate and then by x-co-ordinate.

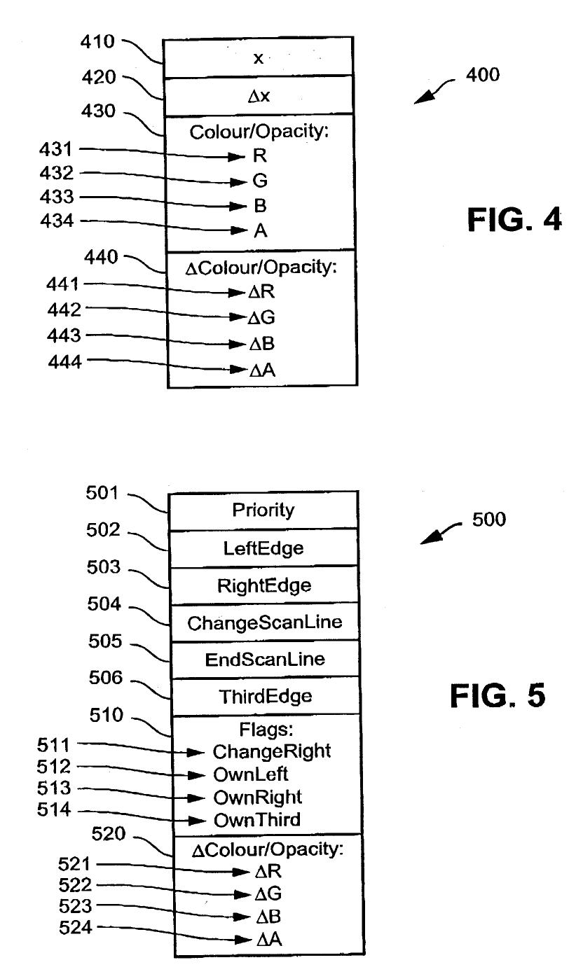

If, at any of steps 204, 206 or 208 of the method 200, it is found that a data structure for an edge has already been created, then the existing data structure is used in the following steps to represent the triangle. Otherwise, correspondingly at steps 205, 207 and 209, edges V₂V₃, V₁V₃ and V₁V₂ are pre-processed so as to create up to three data structures E₁, E₂ and E₃, for edges V₂V₃, V₁V₂ and V₁V₃, respectively. For convenience, the configuration of each of the data structures E₁, E₂ and E₃ created for an edge is shown by the data structure 400 of FIG. 4.

The data structure for an edge is initialised, by the processor 1105, as will now be explained. A field x, 410, is set to the x-coordinate at the point of intersection of the edge and the first scan line that intersects the edge. The phrase ‘the intersection of a scan line and an edge’ as used in the following description refers to the intersection of a line through the center of a scan line and the edge. Field Δx, 420, is set to the difference in x corresponding to a step of one scan line along the edge. Field Color/Opacity, 430, is set to the color and opacity of the edge at the point of intersection of the scan line and the edge. Finally, field ΔColor/Opacity, 440, is set to the difference in color and opacity components corresponding to a step of one scan line along the edge. As an example, for edge E₁, connecting vertices V₂ and V₃ as shown in FIG. 3, the initial values of the fields 410, 420, 430 and 440 may be calculated, for the color R, using the formulas (1) to (5) as follows:

$$\begin{matrix}y ← ⌊ {y}_{2} + \frac{1}{2} ⌋ + \frac{1}{2} & ( 1 ) \\ {E}_{1} \cdot Δ x ← \frac{{x}_{3} - {x}_{2}}{{y}_{3} - {y}_{2}} & ( 2 ) \\ {E}_{1} \cdot x ← {x}_{2} + {E}_{1} \cdot Δ x \times ( y - {y}_{2} ) & ( 3 ) \\ {E}_{1} \cdot Δ R ← \frac{{r}_{3} - {r}_{2}}{{y}_{3} - {y}_{2}} & ( 4 ) \\ {E}_{1} \cdot R ← {r}_{2} + {E}_{1} \cdot Δ R \times ( y - {y}_{2} ) . & ( 5 )\end{matrix}$$

Calculation of remaining colour differences ΔG, 442, and ΔB, 443, and opacity difference ΔA, 444 is analogous to that of ΔR, 441. Calculation of remaining colour components G, 432, and B. 433, and opacity component A, 434, is analogous to that of R, 431.

As scan conversion proceeds, the x difference Δx 420 will be added to the x-co-ordinate x, 410, and the colour and opacity differences 441 through 444 will be added to the colour and opacity components 431 through 434 at the end of processing each scan line. In this manner, the edge data structure 400 for each of the edges V₂V₃, V₁V₃ and V₁V₂, is ready for processing the next scan line.

In one advantageous implementation of the methods described herein, x-co-ordinates are stored in the memory 1106 in floating point form, and colour and opacity values in fixed point form with sixteen fractional bits. The exact data types used may vary depending on accuracy, speed and memory requirements of any given implementation. However, while colour and opacity components are frequently stored in eight-bit fields, this is insufficient to store per-scan line colour differences. As colour and opacity values in field Colour/Opacity, 430, accumulate repeated differences ΔColour/Opacity, 440, rounding errors will also accumulate. Therefore, the fields 410, 420, 430 and 440 need to be implemented to have enough precision.

In the cases where an edge is horizontal or where an edge does not intersect any scan line, no edge data structure 400 is created. Therefore, it is possible for three, two or no edge data structures 400 to be created for any given triangle.

Moving now to step 210 of the method 200, once the edge data structures 400 have been set up, a triangle data structure 500 is created by the processor 1105, unless no edge data structures were either found or created in the preceding steps 201 to 209. In the latter case where no edge data structures were either found or created, the triangle under consideration is not sampled by any scan line and may be ignored.

The configuration of the triangle data structure 500 is shown in FIG. 5. The structure 500, is initialised as follows. If the order in which overlapping triangles are composited is significant, then the priority field 501 is set to a value so as to allow determination of the order of compositing. For example, if triangles are composited in the order in which they are presented at the input, a counter may be incremented each time step 210 is performed and the value of the counter assigned to priority 501. Fields LeftEdge, 502, and RightEdge, 503, are initialized to refer to the edge data structures 400 of the edges of the triangle that are intersected by the first scan line that intersects the triangle. The LeftEdge field 502 is set to refer to the edge on the left (i.e., minimum x) side of the triangle and the RightEdge field 503 is set to refer to the edge on the right (i.e., maximum x) side of the triangle. An EndScanLine field 505 is set to the number of the scan line immediately after the last scan line that intersects the triangle.

If the remaining edge of the triangle is intersected by any scan line, field ThirdEdge, 506, is initialized to refer to the edge data structure of the remaining edge, and field ChangeScanLine, 504, is set to the number of the first scan line that intersects the remaining edge. A flag ChangeRight, 511, is initialized so as to indicate whether the remaining edge is, if the flag is clear, on the left or, if the flag is set, on the right side of the triangle. If the remaining edge is not intersected by any scan line, field ChangeScanLine 504 is initialized to any value greater than or equal to the same scan line number as EndScanLine 505. However, if the remaining edge intersects at least one scan line, the edge lies on the right side if and only if the vertex connecting the right edge and the third edge has a smaller y value than the vertex connecting the left edge and the third edge.

Ownership flags OwnLeft 512, OwnRight 513 and OwnThird 514, as seen in FIG. 5, also need to be initialized. The OwnLeft flag 512 is initialized to indicate whether or not the edge data structure to which the LeftEdge field 502 is set to refer was set up in one of steps 205, 207 or 209 of the method 200. If so, the current triangle is deemed to “own” the edge and is responsible for updating the edge data structure 400, and flag OwnLeft 512 is set. If, however, a data structure was found for the edge in one of steps 204, 206 or 208, then that edge already has an “owner”, and flag OwnLeft 512 is cleared. Similarly, flag OwnRight 513 is initialized to indicate whether or not the right edge of the triangle was set up in one of steps 205, 207 or 209. If the triangle has a third edge is assigned to field ThirdEdge 506, flag OwnThird 514 is initialized to indicate whether or not the third edge was set up in one of steps 205, 207 or 209 of the method 200.

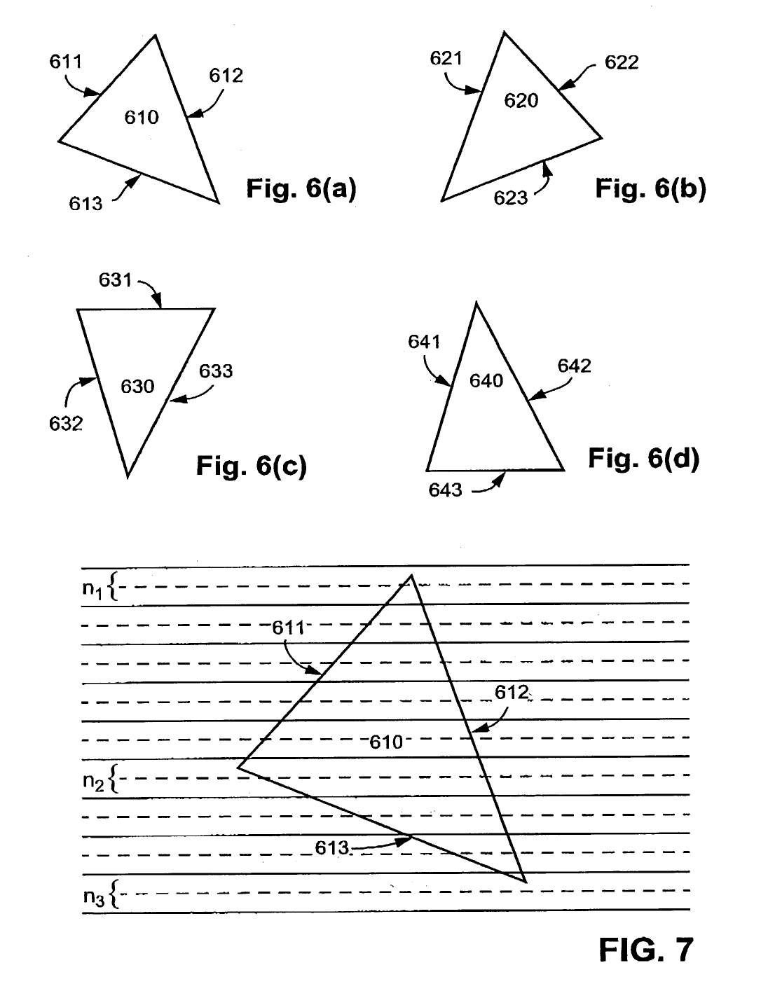

Referring to the examples shown in FIGS. 6(a) to (d), triangle 610 shown in FIG. 6(a) will have field LeftEdge 502 set to refer to the data structure for edge 611, field RightEdge, 503, to edge 612 and field ThirdEdge, 506, to edge 613. The ChangeRight flag 511 will be cleared since the third edge is on the left side of the triangle.

Triangle 620 shown in FIG. 6(b) has corresponding fields LeftEdge 502 and RightEdge 503 set to edges 621 and 622 respectively, and ThirdEdge 506 to edge 623. The ChangeRight flag 511 will be set because the third edge is on the right side of the triangle.

Triangle 630 shown in FIG. 6(c) has corresponding fields LeftEdge 502 and RightEdge 503 set to edges 632 and 633 respectively. Field ThirdEdge 506 and the ChangeRight flag 511 will not be initialised as the remaining edge 631 does not intersect any scan lines.

Triangle 640 shown in FIG. 6(d) has corresponding fields LeftEdge 502 and RightEdge 503 set to edges 641 and 642 respectively. Field ThirdEdge 506 and the ChangeRight flag 511 will not be initialised as the remaining edge 643 does not intersect any scan lines.

FIG. 7 shows triangle 610 in more detail along with scan lines (e.g., n₁) crossing the triangle 610. Referring to FIG. 7, scan line n₁ is the first scan line to intersect triangle 610, and scan line n₁ intersects edges 611 and 612. Scan line n₂ is the first scan line to intersect the remaining edge 613, and hence the field ChangeScanLine 504 of the data structure 500 associated with the triangle 610 is initialized to n₂. Scan line n₃ is the first scan line after the last scan line that intersects the triangle 610, and hence field EndScanLine 505 is initialized to n₃.

Finally, the ΔColour/Opacity field 520 associated with the data structure 500 for the triangle 610 is initialized The values in the field 510 represents the changes in colour and opacity components corresponding to moving one pixel along the scan line, and for Gouraud-shaded triangles is constant for all scan lines and pixels within the triangle 610. Component difference ΔR 521 maybe calculated using formula (6) as follows:

$$Δ R = \frac{( {y}_{3} - {y}_{1} ) ( {r}_{2} - {r}_{1} ) - ( {y}_{2} - {y}_{1} ) ( {r}_{3} - {r}_{1} )}{( {y}_{3} - {y}_{1} ) ( {x}_{2} - {x}_{1} ) - ( {y}_{2} - {y}_{1} ) ( {x}_{3} - {x}_{1} )} . \qquad ( 6 )$$

The remaining component differences ΔG 522, ΔB 523 and ΔA 524 may be calculated in a similar manner using formula (6). A degenerate triangle will result in a zero denominator, and in such a case, the difference values 521, 522, 523 and 524 are not needed and maybe set to zero. The triangle is then added to the bucket corresponding to the first scanline that the triangle intersects (n₁)

Continuing with the method 200 of FIG. 2, once the processor 1105 determines at step 202 that all input triangles have been processed, each of the buckets is sorted at the next step 211. The triangles in the buckets are sorted by the minimum x-co-ordinate of intersection of the triangle and of the scan line represented by the bucket. This is equivalent to sorting by field x, 410, of the edge data structure 400 referred to by field LeftEdge 502 in the triangle data structure 500 for the triangle. Alternatively, sorting may be delayed until the point where each bucket is about to be used, as will be described in the following paragraphs.

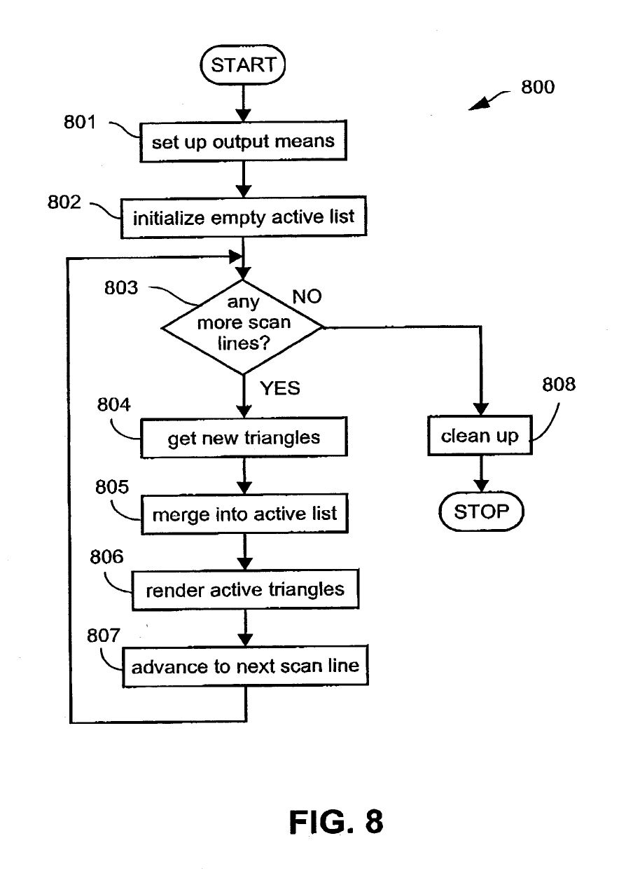

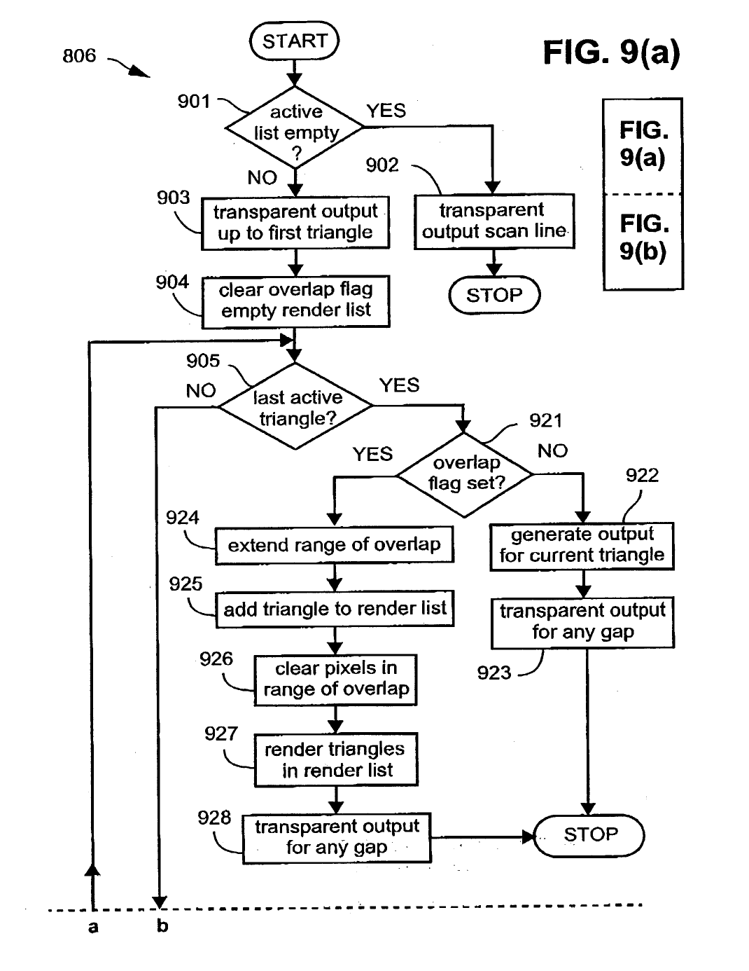

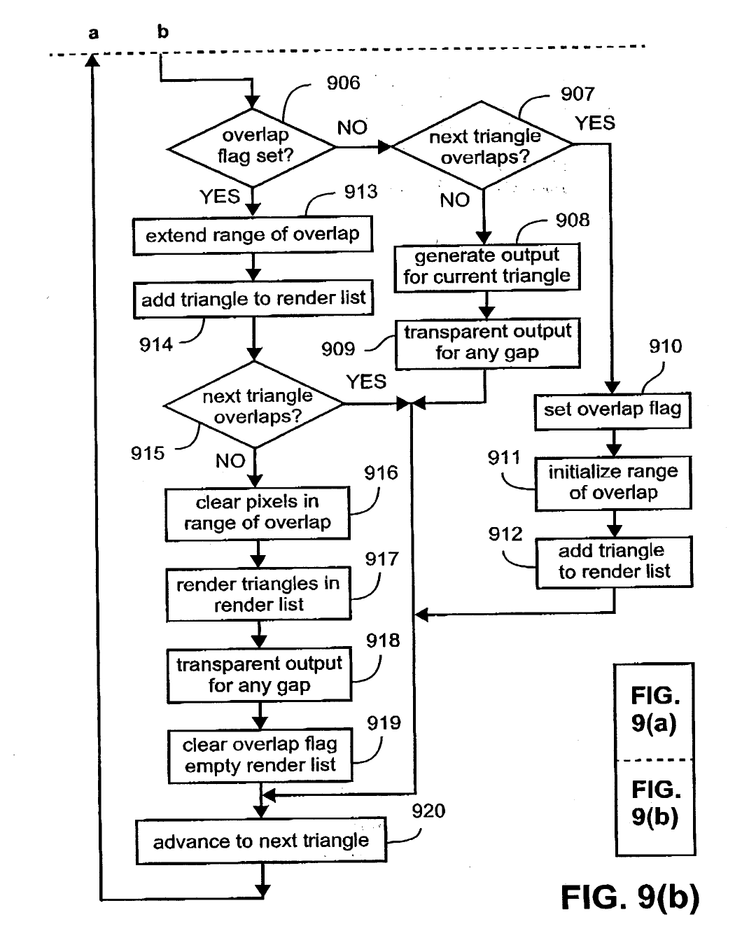

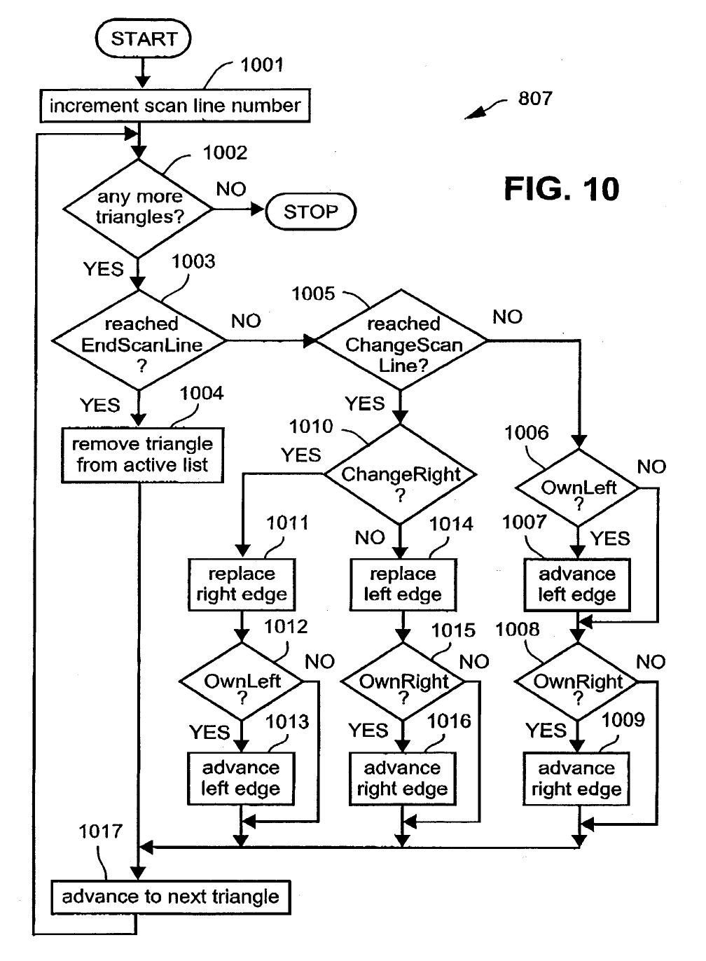

After the method 200 has been executed by the processor 1105, the triangle mesh is rendered scan line by scan line. FIG. 8 is a flow chart showing a method 800 for rendering a triangle mesh. FIG. 9 is a flow chart showing the rendering step 806 in more detail, and FIG. 10 is a flow chart showing the advancing step 807 in more detail.

The method 800 is preferably implemented as software resident on the hard disk drive 1110 and being read and controlled in its execution by the processor 1105. The method 800 begins at step 801, where an output means is set-up to receive rendered output data. For example, step 801 may require the allocation of a pixel buffer by the processor 1105, or obtaining access to the back buffer of an output monitor. Alternatively, step 801 may involve the processor 1105 initialising a data structure to receive run-length encoded image data. If run-length encoded output is required, then, this data structure must be capable of supporting at least three types of run data: (i) transparent runs, which represent runs in which every pixel is fully transparent; (ii) blend runs, which store a start colour and opacity and per-pixel colour and opacity increments, or some equivalent representation of a blend (e.g., a start colour, end colour and run-length); and (iii) uncompressed pixel runs, which store a sequence of uncompressed pixels.

At the next step 802, an active list of triangles is initialized, by the processor 1105, to an empty list. The active list is stored in memory 1106 and contains a list of triangles that intersect the current scan line. The active list will be updated as rendering proceeds from one scan line to the next. The triangles in the active list are kept sorted by the x-co-ordinate of intersection of their left edges with the current scan line.

The method 800 continues at the next step 803, where the processor 1105 determines if there are any more scan lines to be processed. Step 803 controls a loop over all scan lines within the extent of the triangle mesh. At the next step 804, the list of triangles stored in the bucket corresponding to the current scan line is obtained. At step 805, the new triangles are merged into the current active list. As the active list is sorted by the x-co-ordinate of the left edge of each triangle, the list of new triangles similarly needs to be sorted prior to merging. Sorting can either be carried out by the processor 1105 at step 211 as previously described, or may alternatively be carried out as part of step 804. Note that the bucket for a given scan line may commonly be empty, in which case steps 804 and 805 of the method 800 do nothing.

At the next step 806, the triangles in the active list are rendered to produce the output for the current scan line. Then at step 807, the active list, the triangles therein, and the edges the triangles comprise are advanced to the next scan line. These two steps are described in greater detail below.

Finally, when all scan lines have been rendered, any cleaning up that may be required is performed by the processor 1105 at step 808. For example, a portion of the memory 1106 used for storing triangle and edge data structures may need to be deallocated, and output may need to be sent to or displayed on an output device (e.g., the printer 1115 and/or the display device 1114).

Referring now to FIG. 9, the method of rendering the triangles in the active list to generate the output for the current scan line, as executed by the processor 1105 at step 806, begins at sub-step 901, where a test is performed to determine if the active list is empty. If the active list is empty at sub-step 901 then the process of step 806 proceeds to sub-step 902, where a transparent scan line is output. Sub-step 902 depends on how the output is required to be processed. If the output is, for example, an image buffer storing the rendered triangle mesh, the output for the current scan line will consist of transparent pixels. If a run-length encoded representation is required, a fully transparent run covering the scan line needs to be generated. If the rendered triangle mesh is to be composited onto a background using, for example, an “over” compositing operator (as known in the relevant art), then no action needs be taken at all.

If the active list contains at least one triangle, the process of step 806 continues from sub-step 901 to sub-step 903. At sub-step 903, a check is made to determine if there is a gap between the start of the scan line and the first triangle. If there is a gap of at least one pixel, then transparent output needs to be handled for the gap in a similar manner to step 902.

At the next step 904, a flag, stored in memory 1106, called the overlap flag is cleared and a list of triangles called the render list is initialized to an empty list. The process of step 806 proceeds by determining whether the current triangle overlaps at least one other triangle. The overlap flag indicates whether or not the current triangle has been found to overlap at least one other triangle, and, if so, the render list stores, in memory 1106, a list of triangles with the property that each triangle in the list overlaps at least one other triangle in the list.

The process of step 806 continues at the next sub-step 905, where the processor 1105 determines if the triangle currently being examined is the last triangle in the active list Thus, sub-step 905 controls a loop over all active triangles except the last. If the processor 1105 determines that the triangle currently being examined is not the last triangle, then there must be at least one further triangle yet to be examined, and process of step 806 proceeds to sub-step 906.

At sub-step 906, the current value of the overlap flag stored in memory 1106 is examined. If the flag is set, then the current triangle has been found (during the examination of the previous triangle) to overlap at least one previously examined triangle and special processing to handle the case of overlap proceeds at sub-step 913. However, if the overlap flag is clear at sub-step 906, then the current triangle does not overlap earlier triangles (although it may possibly overlap future triangles), and the process of step 806 proceeds to the next sub-step 907.

At sub-step 907, the processor 1105 determines if the current triangle and the next triangle overlap. As triangles are sorted by minimum x-co-ordinate along the scan line, the test at sub-step 907 is a simple test to see if the maximum x-co-ordinate of the current triangle (i.e., the current x-co-ordinate of the right edge) is greater than the next minimum x-co-ordinate of the next triangle (i.e., the current x-co-ordinate of the left edge of the next triangle).

If the current and next triangles in the active list do not overlap, then the process of step 806 continues at sub-step 908, where output data for the current triangle is produced. The output data is a set of pixels whose colour and opacity vary from the colour and opacity at the left edge of the triangle to the colour and opacity at the right edge of the triangle. The colour and opacity are stored in the field Colour/Opacity, 430, of the edge data structure 400 associated with the right edge of the triangle.

The edge data structure of the left and right edges are accessed via fields LeftEdge 502 and RightEdge 503 in the triangle data structure 500. Producing the output data can involve, for example, generating the colour and opacity for each pixel that lies inside the intersection of the triangle with the current scan line using the ΔColour/Opacity field 520.

The resulting pixel data can either be stored in an image buffer or composited with image data already in the image buffer. Alternatively, the output data can be produced by creating, in a run-length encoded image, a run specifying a colour and opacity gradation.

The process of step 806 continues at the next sub-step 909, where a test is executed to determine if there is a gap of one or more pixels between the current triangle and the next triangle in the active list, and, if so, handling transparent data for the pixels in the gap as described for sub-step 902. The process of step 806 then proceeds with sub-step 920.

If the processor 1105 determines, at sub-step 907, that the current and next triangles overlap, then the process of step 806 continues at sub-step 910. At sub-step 910, the overlap flag is set to indicate that an overlap has been detected. At the next sub-step 911, the range of pixel co-ordinates spanned by the current triangle on the current scan line is recorded as the range of overlap. The range of overlap will be extended as necessary to include the next and any subsequent overlapping triangles in future iterations. At the next sub-step 912, the current triangle is added to the render list and the process of step 806 continues at sub-step 920.

Returning now to sub-step 906, if the overlap flag stored in memory 1106 has been set, then the process of step 806 for the current triangle proceeds at sub-step 913. At sub-step 913, the range of overlap initialized at sub-step 911 is extended if necessary to include the range of pixels on the current scan line that is spanned by the current triangle. At the next sub-step 914, the processor 1105 adds the current triangle to the render list. At the next sub-step 915, the next triangle in the active list is examined by the processor 1105 to determine if the next triangle overlaps any of the triangles in the render list. Sub-step 915 determines whether the minimum x-co-ordinate of the next triangle is less than the maximum x-co-ordinate of the range of overlap. If the next triangle does overlap at least one triangle in the render list, the process of step 806 proceeds to sub-step 920 to continue with the next iteration. If, however, the next triangle does not overlap any triangle in the render list at sub-step 915, then the group of overlapping triangles in the render list can be rendered, in which case the process of step 806 continues to sub-step 916.

At sub-step 916, the pixels in the range of overlap are initialized to fully transparent. If run-length encoded output data is being produced, then a portion of memory 1106 used for a run of uncompressed pixel data spanning the pixels in the range of overlap needs to be allocated first. Then at sub-step 917, the triangles in the render list are composited into the output buffer or into the allocated uncompressed run. Any suitable method of compositing as known in the relevant art can be used at sub-step 917. However, two classes of compositing methods are of note, being order-dependent and order-independent compositing.

In order-dependent compositing, the order in which triangles are composited is significant, in that changing the order may, and typically will, change the final appearance of the output. One simple method for order-dependent compositing is to start with a transparent background and to composite each triangle onto the background using the “over” compositing operator as known in the relevant art. If order-dependent compositing is used, the triangles in the render list need to be sorted by the priority field 501 of the triangle data structure 500 prior to compositing as part of the rendering sub-step 917.

In order-independent compositing, the order in which triangles are composited is not significant. One simple method for order-independent compositing is to start with a transparent background and to composite each triangle with the background using the “plus” compositing operator as known in the relevant art.

Alternatively, another known method for order-independent compositing can be used where for each overlapping region, an average color is calculated by accumulating the contribution of each triangle at each pixel within the overlapping region along with the number of contributing triangles at each pixel, and dividing the accumulated color by the number of triangles at each pixel.

For two overlapping objects, one with color c₁ and opacity o₁, and the other with color c₂ and opacity o₂, still another more sophisticated known method for order-independent compositing can be performed by mixing contributing colours c₁ and c₂ and simulating the superposition of one object on the other utilising the “over” operator. In this further known method, the opacity is increased as more and more contributing colors are superimposed. The formula (7) for this further known method giving the resulting region of overlap is as follow:

$$\begin{matrix}( \frac{\sum {c}_{i} {o}_{i} / n}{\sum {o}_{i} / n} , {over}_{i = 1}^{n} {o}_{i} ) = ( \frac{\sum {c}_{i} {o}_{i}}{\sum {o}_{i}} , {over}_{i = 1}^{n} {o}_{i} ) , & ( 7 ) \\ where {over}_{i = 1}^{n} {o}_{i} = {\sum }_{i = 1}^{n} {o}_{i} {\prod }_{j = i + 1}^{n} ( 1 - {o}_{j} ) , & \end{matrix}$$

ie., the opacity of (x, o₁) over (x, o₂) . . . over (x, oₙ). Further, n is the number of overlapping triangles over each portion of the range of overlap. The method of formula (7) yields a result without discontinuities.

Once the triangles have been rendered at sub-step 917, a check is made at sub-step 918 to determine if there is a gap of one or more pixels between the end of the range of overlap and the next triangle in the active list, and, if so, transparent pixels are output in the gap as described above for sub-step 909. The overlap flag is cleared and the render list emptied at sub-step 919 in preparation for any further groups of overlapping triangles that may be encountered. Then at the next sub-step 920, the process of step 806 advances to the next triangle in the active list and the process continues at sub-step 905.

When the last triangle in the active list is reached at sub-step 905, the process of step 806 continues at sub-step 921. Processing for the last triangle is simpler than the previous triangles as there are no further triangles that may overlap the last triangle, although the last triangle itself may overlap earlier triangles. At sub-step 921, the processor 1105 determines if the overlap flag is set. If the overlap flag is clear, then the last triangle in the active list does not overlap any earlier triangle, so, at sub-step 922, output may be generated for the last triangle in the same manner as described above for sub-step 908. Then at sub-step 923 the processor 1105 determines if there is a gap of one or more pixels between the end of the last triangle and the end of the output scan line, and, if so, transparent output is handled for the remaining pixels as described above.

If, however, the overlap flag is set at sub-step 921, the process of step 806 continues at sub-step 924, where, as at sub-step 913, the range of overlap is extended if necessary to include the last triangle. At the next sub-step 925, the last triangle is added to the render list. Then at sub-step 926, the pixels in the range of overlap are initialized as in sub-step 916. At the next sub-step 927, the triangles in the render list are rendered as in sub-step 917. The process of step 806 concludes at sub-step 928, where the processor 1105 determines if there is a gap of one or more pixels between the end of the range of overlap and the end of the output scan line, and, if so, transparent output is handled for the remaining pixels.

Once the output for the current scan line has been generated at step 806, the triangles in the active list are advanced to the next scan line at step 807.

The process of step 807 begins at sub-step 1001 as seen in FIG. 10. At sub-step 1001, the processor 1105 increments the current scan line number. At the next sub-step 1002, if there are any more triangles in the active list, the process of step 807 continues at sub-step 1003. At sub-step 1003, the processor 1105, determines whether or not the value of the EndScanLine field 505 associated with the current triangle is equal to the current scan line number. If so, the current triangle does not intersect any more scan lines and the current triangle is removed from the active list at the next sub-step 1004. The process of step 807 then continues at the next sub-step 1017, where the next triangle in the active list is accessed.

If the processor 1105 determines at sub-step 1003, that further scan-line intersections will occur with the current triangle, the edges of the triangle need to be updated in order to be ready for producing the next scan line of output. At the next sub-step 1005, the value of the ChangeScanLine field 504 associated with the current triangle is compared with the current scan line number. If the value of the ChangeScanLine is field 504 associated with the current triangle is unequal to the current scan line number then the process of step 807 proceeds to sub-step 1006.

At sub-step 1006, the processor 1105 determines if the current triangle is responsible for updating the left edge of the triangle. Thus, if the OwnLeft flag 512 is set, the process of step 807 proceeds to sub-step 1007. At sub-step 1007, the edge data structure referred to by the LeftEdge field 502 associated with the current triangle is advanced to the next scan line. Sub-step 1007 adds the value of Δx 420 to x 410, and adds each of the components of ΔColour/Opacity field 440 to the corresponding components of the Colour/Opacity field 430. If the OwnLeft flag 512 associated with the current triangle is clear, then the left edge of the triangle is the responsibility of some other triangle and step 1007 is not performed.

Similarly at step 1008, the OwnRight flag 513 is tested, and, if set, the edge referred to by the RightEdge field 503 associated with the current triangle is advanced to the next scan line at step 1009. The process of step 807 then proceeds to step 1017 and the process of step 807 iterates with the next triangle.

If at step 1005 the processor 1105 determines that the current scan line number equals the ChangeScanLine field 504 associated with the current triangle, then the process of step 807 proceeds to step 1010. Thus, the current scan line has been advanced beyond one of the edges of the current triangle and there is another edge to take the place of the previous. For example, when the current scan line has been advanced to scan line n₂ as shown in FIG. 7, the edge 611 no longer has any scan-line intersections and edge 613 takes the place of the edge 611 in the remaining processing.

At step 1010, the processor 1105 examines the ChangeRight flag 511 associated with the current triangle in order to determine which edge is to be replaced. If the ChangeRight flag 511 is set, then the right edge is to be replaced and processing continues at step 1011. At step 1011, the RightEdge field 503 associated with the current triangle is assigned the value of the ThirdEdge field 506, and the OwnRight flag 513 is assigned the value of the OwnThird field 514. Then, at step 1012, the OwnLeft flag 512 is examined by the processor 1105 as at step 1006, and, if set, step 1013 is executed by the processor 1105 performing the same tasks as at step 1007. The process of step 807 then proceeds to step 1017.

If, the ChangeRight flag 511 is clear at step 1010, then the left edge of the current triangle is to be replaced and processing continues at step 1014. At step 1014, the LeftEdge field 502 is assigned the value of the ThirdEdge field 506, and the OwnLeft flag 512 is assigned the value of the OwnThird field 514. Then, at step 1015, the OwnRight flag 513 is examined by the processor as at step 1008, and, if set, step 1016 is executed, in the same manner as step 1009 described above The process of step 807 then proceeds to step 1017.

At step 1017, the processor 1105 continues examination with the next triangle in the active list and the process returns to step 1002. In this manner, all triangles in the active list are either updated to be ready for producing the next scan line of output, or they no longer have scan-line intersections and are consequently removed from the active list.

The aforementioned preferred methods comprise a particular control flow. There are many other variants of the preferred methods, which use different control flows without departing the spirit or scope of the invention. Furthermore one or more of the steps of the preferred methods may be performed in parallel rather than sequentially.

The foregoing describes only some embodiments of the present invention, and modifications and/or changes can be made thereto without departing from the scope and spirit of the invention, the embodiments being illustrative and not restrictive.

The claims defining the invention are as follows:

1. A method of rendering a graphical object comprising a region of shaded color and/or opacity information, said region being divided into a plurality of triangular regions to form a triangle mesh representing said region, where one or more triangular regions of said mesh overlap, said method comprising the steps of:
(i) sorting said triangular regions in a predetermined direction to determine which of said triangular regions overlap in said predetermined direction;
(ii) compositing colour and/or opacity information associated at least with the overlapping triangular regions into an intermediate buffer; and
(iii) rendering said object according to said information contained in said intermediate buffer.

2. A method according to claim 1, wherein said triangular regions are rendered on a scan-line basis.

3. A method according to claim 1, wherein colour and/or opacity information associated with one or more of said triangular regions of said mesh varies within said triangle.

4. A method according to claim 1, wherein said overlapping triangular regions are composited in an order-dependent manner.

5. A method according to claim 1, wherein said overlapping triangular regions are composited in an order-dependent manner using an over operator.

6. A method according to claim 1, wherein said overlapping triangular regions are composited in an order-independent manner.

7. A method according to claim 1, wherein said overlapping triangular regions are composited in an order-independent manner and wherein an average color is calculated for said triangular regions by accumulating a contribution of each triangular region to said image, and dividing said accumulated color by a number of triangular regions.

8. A method according to claim 1, wherein said overlapping triangular regions are composited in an order-independent manner and wherein an average color is calculated for said triangular regions as follows:
$$( \frac{\sum {c}_{i} {o}_{i} / n}{\sum {o}_{i} / n} , {over}_{i = 1}^{n} {o}_{i} ) = ( \frac{\sum {c}_{i} {o}_{i}}{\sum {o}_{i}} , {over}_{i = 1}^{n} {o}_{i} ) ,$$
where cᵢ represents a colour and oᵢ an opacity of an ith triangular region, n represents the number of parametric coordinates and
$${over}_{i = 1}^{n} {o}_{i} = {\sum }_{i = 1}^{n} {o}_{i} {\prod }_{j = i + 1}^{n} ( 1 - {o}_{j} ) .$$

9. A method according to claim 1, wherein said intermediate buffer is configured to receive pixel data as a result of said compositing at step (ii).

10. A method according to claim 9, wherein said intermediate buffer is a scan-line buffer.

11. A method according to claim 10, wherein step (i) includes the further sub-step of examining an active list associated with said mesh of triangular regions to determine which of said triangular regions of said mesh overlap, said active list being sorted based on one co-ordinate of said mesh of triangular regions.

12. A method of rendering a graphical object comprising a region of shaded color and/or opacity information, said region being divided into a plurality of triangular regions to form a triangle mesh representing said region, where one or more triangular regions of said mesh overlap, said method comprising the steps of:
(i) determining regions of overlap between said triangular regions;
(ii) compositing colour and/or opacity information associated at least with those triangular regions which overlap in a predetermined direction, into an intermediate buffer; and
(iii) rendering said object according to said information contained in said intermediate buffer.

13. A method according to claim 12, wherein said triangular regions are rendered on a scan-line basis.

14. A method according to claim 12, wherein colour and/or opacity information associated with one or more of said triangular regions of said mesh varies within said triangle.

15. A method according to claim 12, wherein said triangular regions are composited in an order-dependent manner.

16. A method according to claim 12, wherein said triangular regions are composited in an order-dependent manner using an over operator.

17. A method according to claim 12, wherein said triangular regions are composited in an order-independent manner.

18. An apparatus for rendering a graphical object comprising a region of shaded color and/or opacity information, said region being divided into a plurality of triangular regions to form a triangle mesh representing said region, where one or more triangular regions of said mesh overlap, said apparatus comprising:
sorting means for sorting said triangular regions in a predetermined direction to determine which of said triangular regions overlap in said predetermined direction;
compositing means for compositing colour and/or opacity information associated at least with the overlapping triangular regions into an intermediate buffer; and
rendering means for rendering said object according to said information contained in said intermediate buffer.

19. An apparatus according to claim 18, wherein said triangular regions are rendered on a scan-line basis.

20. An apparatus according to claim 18, wherein colour and/or opacity information associated with one or more of said triangular regions of said mesh varies within said triangle.

21. An apparatus according to claim 18, wherein said overlapping triangular regions are composited in an order-dependent manner.

22. An apparatus according to claim 18, wherein said overlapping triangular regions are composited in an order-dependent manner using an over operator.

23. An apparatus according to claim 18, wherein said overlapping triangular regions are composited in an order-independent manner.

24. An apparatus for rendering a graphical object comprising a region of shaded color and/or opacity information, said region being divided into a plurality of triangular regions to form a triangle mesh representing said region, where one or more triangular regions of said mesh overlap, said apparatus comprising:
region overlap determining means for determining regions of overlap between said triangular regions;
compositing means for compositing colour and/or opacity information associated at least with those triangular regions which overlap in a predetermined direction, into an intermediate buffer; and
rendering means for rendering said object according to said information contained in said intermediate buffer.

25. An apparatus according to claim 24, wherein said triangular regions are rendered on a scan-line basis.

26. An apparatus according to claim 24, wherein colour and/or opacity information associated with one or more of said triangular regions of said mesh varies within said triangle.

27. An apparatus according to claim 24, wherein said triangular regions are composited in an order-dependent manner.

28. An apparatus according to claim 24, wherein said triangular regions are composited in an order-dependent manner using an over operator.

29. An apparatus according to claim 24, wherein said triangular regions are composited in an order-independent manner.

30. A computer program for rendering a graphical object comprising a region of shaded color and/or opacity information, said region being divided into a plurality of triangular regions to form a triangle mesh representing said region, where one or more triangular regions of said mesh overlap, said program comprising:
code for sorting said triangular regions in a predetermined direction to determine which of said triangular regions overlap in said predetermined direction;
code for compositing colour and/or opacity information associated at least with the overlapping triangular regions into an intermediate buffer; and
code for rendering said object according to said information contained in said intermediate buffer.

31. A computer program for rendering a graphical object comprising a region of shaded color and/or opacity information, said region being divided into a plurality of triangular regions to form a triangle mesh representing said region, where one or more triangular regions of said mesh overlap, said program comprising:
code for determining regions of overlap between said triangular regions;
code for compositing colour and/or opacity information associated at least with those triangular regions which overlap in a predetermined direction, into an intermediate buffer; and
code for rendering said object according to said information contained in said intermediate buffer.
